(19) United States
(12) Patent Application Publication
(10) Pub. No.: US 2024/0330977 A1
(43) Pub. Date: Oct. 3, 2024

(54) AUTOMATIC KEYWORD GROUPING FOR CAMPAIGN BID CUSTOMIZATION

(71) Applicant: Maplebear Inc. (dba Instacart), San Francisco, CA (US)

(72) Inventors: Cheng Jia, San Jose, CA (US); Justin Miller, Seattle, WA (US); Yan Zhuang, Ellicott City, MD (US); Anvar Gazizov, Kitchener (CA); Hassan Djirdeh, MISSISSAUGA (CA); Aakarsh Madhavan, Toronto (CA); Brijendra Nag, Toronto (CA); Ji Chao Zhang, Toronto (CA)

(21) Appl. No.: 18/129,447

(22) Filed: Mar. 31, 2023

(51) Int. Cl. G06Q 30/0242; G06Q 30/0273

(52) U.S. Cl. CPC G06Q 30/0243; G06Q 30/0275

(57) ABSTRACT

A keyword campaign automatically groups keywords for customized override bids for the keyword group. The keywords of a campaign may be analyzed by a computer model to predict membership in a category in addition to the likelihood that the bid of the keyword will be modified. The keyword groups may be automatically generated based on the predictions, and performance metrics are evaluated for the keyword groups at one or more modified bids. The performance metrics of the keyword groups at the modified bids may then be used to set override bids. The automatically generated keyword groups and performance metrics permit a sponsor to intelligently group and customize keyword bids with reduced interface interactions and without requiring individual keyword bid adjustments.

### BACKGROUND

This disclosure relates generally to computer hardware and software for optimizing content campaign bidding and more specifically to automatically generating keyword groups for customizing keyword bids.

Many online systems select and provide content to users based on content campaigns from a sponsor. The sponsored content may include content provided to users based on keywords associated with the content campaign, such that when a user enters terms (e.g., for a search) or terms that are otherwise relevant (e.g., for content being viewed by the user), the terms are matched with keywords to identify relevant content campaigns. In some cases, the keywords for a campaign may include hundreds, thousands, or more individual keywords used to determine whether to present the sponsored content of the campaign. For example, sponsored content for a breakfast cereal may include keywords related to breakfast, cereal, the type of cereal, one or more brands relevant to the cereal, ingredients of the cereal, and more. Individual keywords may also include variations and different combinations of these keywords. As such, while the total number of keywords for a campaign may help increase the reach of the campaign and opportunities for the campaign to be presented to users, it can make more fine-grained management of the campaign unwieldy. For example, rather than a single bid amount for all keywords in the campaign, sponsors may wish to customize the bid amounts for individual keywords.

This may be difficult using conventional systems and processes, as not only may a sponsor need to individually set an override bid for each keyword (i.e., different from the default campaign bid), but sponsors may also have a limited ability to predict the effect of modifying the bid for the keywords. In addition, the sponsor may wish to have a group of keywords use a higher or lower bid than a standard or “default” bid for the campaign, but not readily know which keywords to group together. As the number of keywords for a campaign increases, the difficulty in managing the large number of keywords (which may be necessary to effectively achieve a desired reach and/or number of impressions) may thus also increase. Moreover, this increased complexity and difficulty also may present various technical computing challenges, particularly when trying to optimize for the consumption of processing power, network bandwidth, and/or other computing resources.

### SUMMARY

In accordance with one or more aspects of the disclosure, an online system automatically groups keywords in a campaign, forming a keyword group for which an override bid is set and thereby enabling easier customization of keyword bids for the campaign without requiring keyword-by-keyword interactions by the sponsor. The online system may automatically identify keywords for the group (which may, e.g., be a subset of all keywords of the campaign) with respect to a category or property of the keywords. For example, grouping keywords that are “most popular” or “most relevant” to the content for the sponsor to review the keyword group and set an override bid for the group of keywords. In addition to the designated category (e.g., relevance or popularity), the online system may also select keywords for the group based on a likelihood that the sponsor will set an override bid for the keyword. In some embodiments, the keywords for the keyword group are selected based on a trained computer model (e.g., one or more classifiers) that may be trained, in part, on prior campaigns by the sponsor and by other sponsors, enabling the model to predict the groupings with consideration of prior bid modifications.

To aid the sponsor (acting through an associated user) in evaluating whether and how much to modify the bid for the automatically-identified keyword group, the online system may also estimate a number of performance metrics for performance of the campaign if the bid for the group is set to one or more different bid amounts (e.g., relative to the current default bid associated with the campaign as a whole).

To enhance interaction of the online system for the sponsor, the online system may generate, present, and/or otherwise provide an interface for a user associated with the sponsor to view the keyword group, as well as the estimated performance metrics and select a modified bid for the keyword group. This permits the sponsor to readily modify the bid for keyword groups easily in a campaign and automatically and without individually modifying the bids for each keyword or individually selecting constituent keywords for the group. Because the keyword groups may be generated automatically, users may quickly set up campaigns with a large number of keywords with customized bid amounts across different keywords quickly and easily with intelligent, automatic keyword grouping and informed by the estimated effects of the modified bid on the campaign as a whole.

### BRIEF DESCRIPTION OF THE DRAWINGS

FIG. 1 is a block diagram of a system environment in which an online system, such as an online concierge system, operates, according to one or more embodiments.

FIG. 2 illustrates an environment of an online concierge service, according to one or more embodiments.

FIG. 3 is a diagram of an online concierge system, according to one or more embodiments.

FIG. 4A is a diagram of a customer mobile application (CMA), according to one or more embodiments.

FIG. 4B is a diagram of a shopper mobile application (SMA), according to one or more embodiments.

FIG. 5 shows an example of keyword grouping and group bid setting for a keyword campaign, according to one or more embodiments.

FIG. 6 is an example flowchart for a method related to content campaigns with different bids for keyword groups, according to one or more embodiments.

FIGS. 7A-B are example user interfaces for a user device operated by a user associated with a campaign sponsor, according to one or more embodiments.

The figures depict embodiments of the present disclosure for purposes of illustration only. Alternative embodiments of the structures and methods illustrated herein may be employed without departing from the principles, or benefits touted, of the disclosure described herein.

### DETAILED DESCRIPTION

### System Architecture

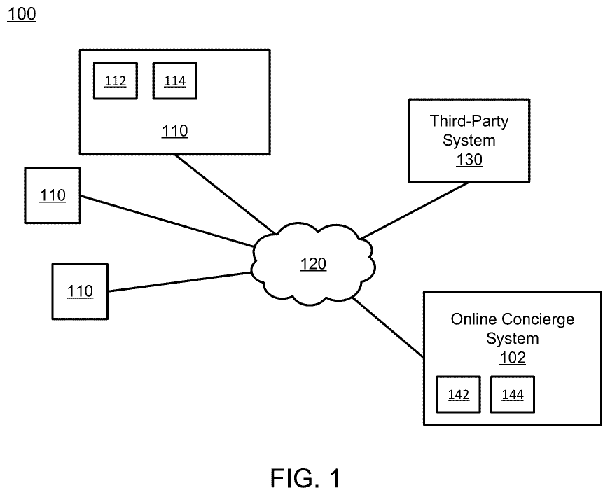

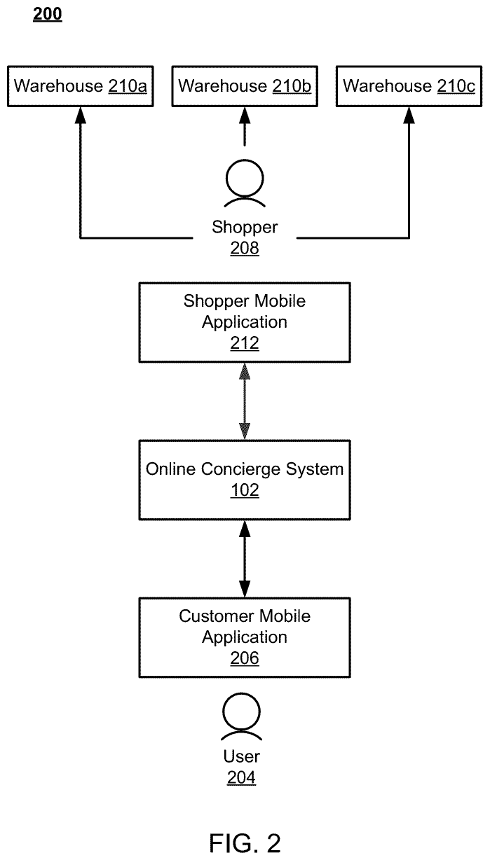

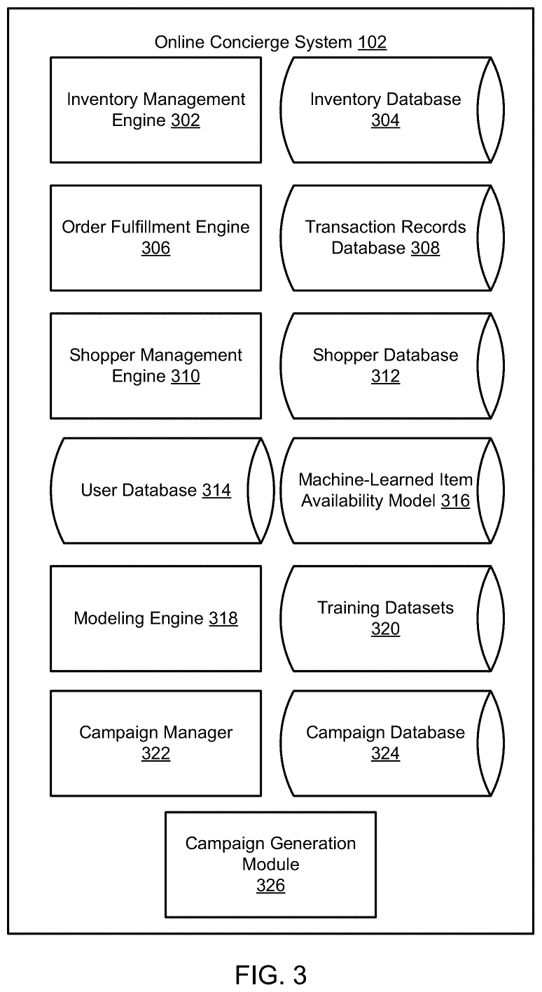

FIG. 1 is a block diagram of a system environment 100 in which an online system, such as an online concierge system 102 as further described below in conjunction with FIGS. 2 and 3, operates, according to one or more embodiments. The system environment 100 shown by FIG. 1 comprises one or more client devices 110, a network 120, one or more third-party systems 130, and the online concierge system 102. In alternative configurations, different and/or additional components may be included in the system environment 100. Additionally, in other embodiments, the online concierge system 102 may be replaced by an online system configured to retrieve content for display to users and to transmit the content to one or more client devices 110 for display.

In particular, the online system in this environment may select and provide promoted content based on keywords. The keywords for a particular content campaign may have different associated bid amounts for different keywords and keyword groups that differ from the bid for the campaign as a whole. As discussed further below, as the number of keywords for a campaign may be very large (e.g., 100s, 1,000s, 10,000s), the online concierge system 102 automatically generates groups of keywords that may relate to one or more categories and assist in setting an override bid for a keyword group that is different from the overall campaign bid. The online concierge system 102 may also estimate performance characteristics of the keyword group at various modified bids and present the groups and estimated performance characteristics to the sponsor in an interface to improve the sponsor's ability to customize keyword bids, particularly for campaigns with a large number of keywords. While this approach for setting keyword bids is discussed below in the context of an online concierge system 102, these features may be applied in other systems and contexts in which keyword bids may be set for a content campaign in various other types of systems, such as other content search systems that use keywords for identifying content.

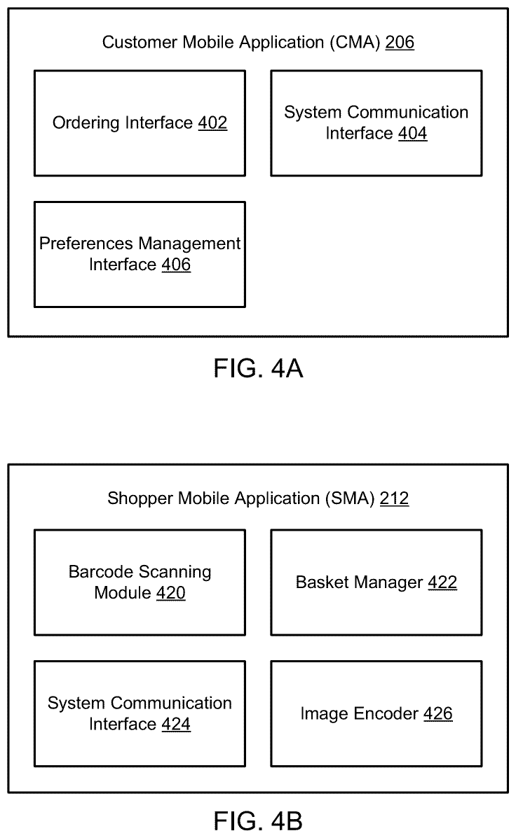

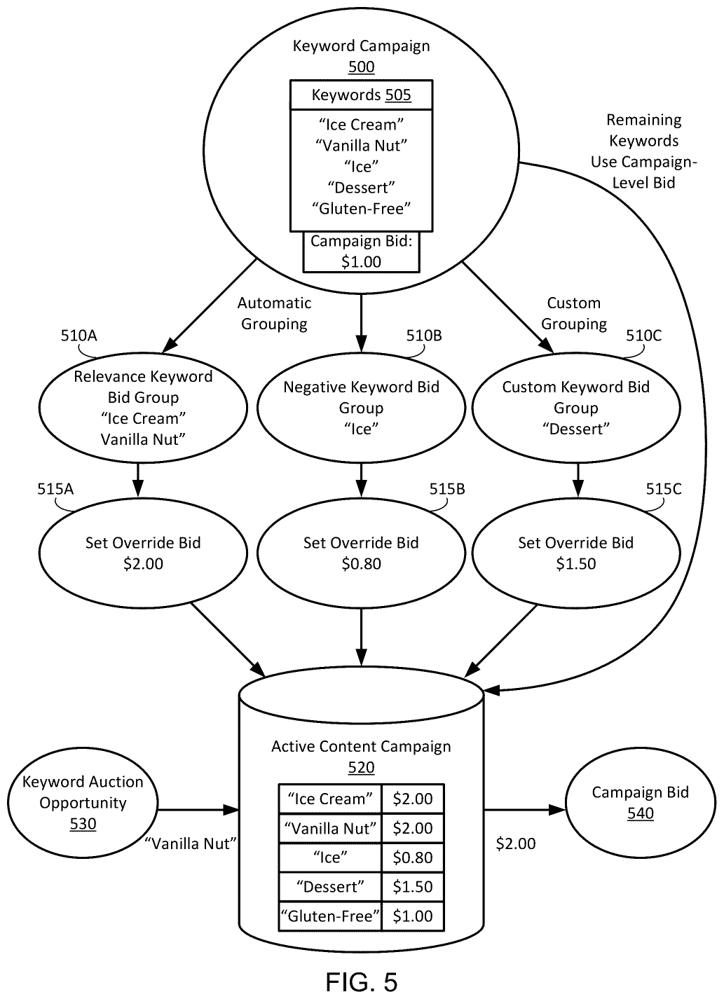

The client devices 110 are one or more computing devices capable of receiving user input as well as transmitting and/or receiving data via the network 120. In one embodiment, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online concierge system 102. For example, the client device 110 executes a customer mobile application 206 or a shopper mobile application 212, as further described below in conjunction with FIGS. 4A and 4B, respectively, to enable interaction between the client device 110 and the online concierge system 102. As another example, a client device 110 executes a browser application to enable interaction between the client device 110 and the online concierge system 102 via the network 120. In another embodiment, a client device 110 interacts with the online concierge system 102 through an application programming interface (API) running on a native operating system of the client device 110, such as IOS® or ANDROID™.

A client device 110 includes one or more processors 112 configured to control operation of the client device 110 by performing functions. In various embodiments, a client device 110 includes a memory 114 comprising a non-transitory storage medium on which instructions are encoded. The memory 114 may have instructions encoded thereon that, when executed by the processor 112, cause the processor to perform functions to execute the customer mobile application 206 or the shopper mobile application 212 to provide the functions further described above in conjunction with FIGS. 4A and 4B, respectively.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third-party systems 130 may be coupled to the network 120 for communicating with the online concierge system 102 or with the one or more client devices 110. In one embodiment, a third-party system 130 is an application provider communicating information describing applications for execution by a client device 110 or communicating data to client devices 110 for use by an application executing on the client device. In other embodiments, a third-party system 130 provides content or other information for presentation via a client device 110. For example, the third-party system 130 stores one or more web pages and transmits the web pages to a client device 110 or to the online concierge system 102. The third-party system 130 may also communicate information to the online concierge system 102, such as advertisements, content, or information about an application provided by the third-party system 130.

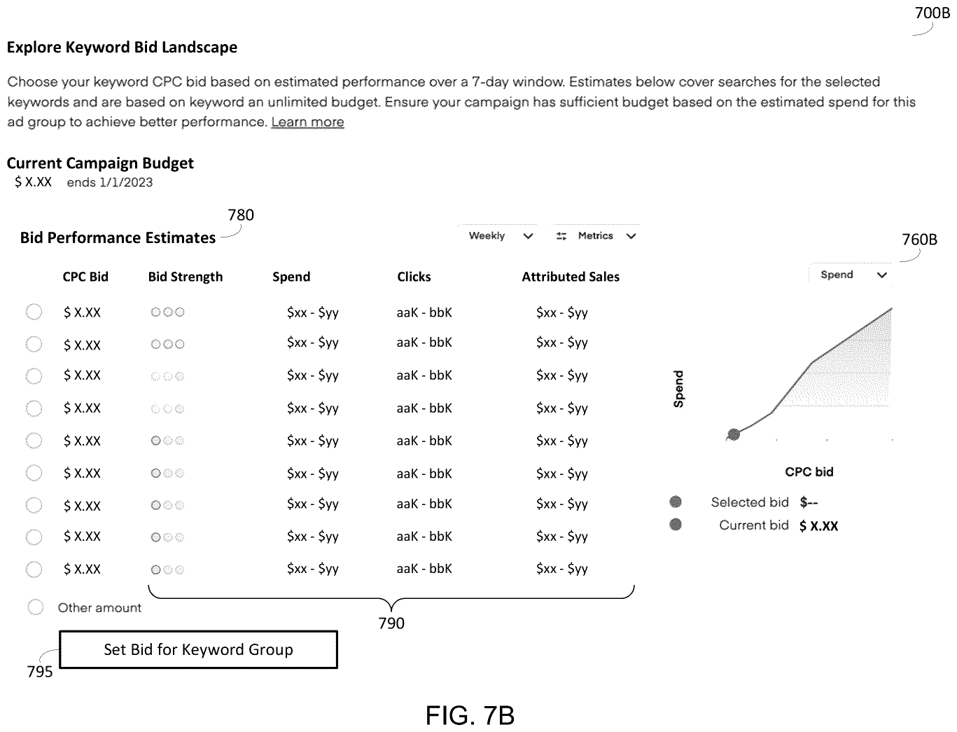

The online concierge system 102 includes one or more processors 142 configured to control operation of the online concierge system 102 by performing functions. In various embodiments, the online concierge system 102 includes a memory 144 comprising a non-transitory storage medium on which instructions are encoded. The memory 144 may have instructions encoded thereon corresponding to the modules further below in conjunction with FIG. 3 that, when executed by the processor 142, cause the processor to perform the functionality further described above in conjunction with FIGS. 2 and 5-7B. For example, the memory 144 has instructions encoded thereon that, when executed by the processor 142, cause the processor 142 to group keywords, determine performance metrics, and set an override bid for the keyword group as discussed further below. The memory 144 may include instructions for generating a user interface (or information provided to another client device 110 for forming the user interface) to provide the functionality of the interfaces shown in FIGS. 7A-B. Additionally, the online concierge system 102 includes a communication interface configured to connect the online concierge system 102 to one or more networks, such as network 120, or to otherwise communicate with devices (e.g., client devices 110) connected to the one or more networks.

One or more of a client device 110, a third-party system 130, or the online concierge system 102 may be special purpose computing devices configured to perform specific functions, as further described below in conjunction with FIGS. 2-7B, and may include specific computing components such as processors, memories, communication interfaces, and/or the like.

### System Overview

FIG. 2 illustrates an environment 200 of an online platform, such as an online concierge system 102, according to one or more embodiments. The figures use like reference numerals to identify like elements. A letter after a reference numeral, such as “210a,” indicates that the text refers specifically to the element having that particular reference numeral. A reference numeral in the text without a following letter, such as “210,” refers to any or all of the elements in the figures bearing that reference numeral. For example, “210” in the text refers to reference numerals “210a” or “210b” in the figures.

The environment 200 includes an online concierge system 102. The online concierge system 102 is configured to receive orders from one or more users 204 (only one is shown for the sake of simplicity). An order specifies a list of goods (items or products) to be delivered to the user 204. The order also specifies the location to which the goods are to be delivered, and a time window during which the goods should be delivered. In some embodiments, the order specifies one or more retailers from which the selected items should be purchased. The user may use a customer mobile application (CMA) 206 to place the order; the CMA 206 is configured to communicate with the online concierge system 102.

The online concierge system 102 is configured to transmit orders received from users 204 to one or more shoppers 208. A shopper 208 may be a contractor, employee, other person (or entity), robot, or other autonomous device enabled to fulfill orders received by the online concierge system 102. The shopper 208 travels between a warehouse and a delivery location (e.g., the user's home or office). A shopper 208 may travel by car, truck, bicycle, scooter, foot, or other mode of transportation. In some embodiments, the delivery may be partially or fully automated, e.g., using a self-driving car. The environment 200 also includes three warehouses 210a, 210b, and 210c (only three are shown for the sake of simplicity; the environment could include hundreds of warehouses). The warehouses 210 may be physical retailers, such as grocery stores, discount stores, department stores, etc., or non-public warehouses storing items that can be collected and delivered to users. Each shopper 208 fulfills an order received from the online concierge system 102 at one or more warehouses 210, delivers the order to the user 204, or performs both fulfillment and delivery. In one embodiment, shoppers 208 make use of a shopper mobile application 212 which is configured to interact with the online concierge system 102.

FIG. 3 is a diagram of an online concierge system 102, according to one or more embodiments. In various embodiments, the online concierge system 102 may include different or additional modules than those described in conjunction with FIG. 3. Further, in some embodiments, the online concierge system 102 includes fewer modules than those described in conjunction with FIG. 3.

The online concierge system 102 includes an inventory management engine 302, which interacts with inventory systems associated with each warehouse 210. In one embodiment, the inventory management engine 302 requests and receives inventory information maintained by the warehouse 210. The inventory of each warehouse 210 is unique and may change over time. The inventory management engine 302 monitors changes in inventory for each participating warehouse 210. The inventory management engine 302 is also configured to store inventory records in an inventory database 304. The inventory database 304 may store information in separate records-one for each participating warehouse 210—or may consolidate or combine inventory information into a unified record. Inventory information includes attributes of items that include both qualitative and qualitative information about items, including size, color, weight, stock keeping unit (SKU), serial number, and so on. In one embodiment, the inventory database 304 also stores purchasing rules associated with each item, if they exist. For example, age-restricted items such as alcohol and tobacco are flagged accordingly in the inventory database 304. Additional inventory information useful for predicting the availability of items may also be stored in the inventory database 304. For example, for each item-warehouse combination (a particular item at a particular warehouse), the inventory database 304 may store a time that the item was last found, a time that the item was last not found (a shopper looked for the item but could not find it), the rate at which the item is found, and the popularity of the item.

For each item, the inventory database 304 identifies one or more attributes of the item and corresponding values for each attribute of an item. For example, the inventory database 304 includes an entry for each item offered by a warehouse 210, with an entry for an item including an item identifier that uniquely identifies the item. The entry includes different fields, with each field corresponding to an attribute of the item. A field of an entry includes a value for the attribute corresponding to the attribute for the field, allowing the inventory database 304 to maintain values of different categories for various items.

In various embodiments, the inventory management engine 302 maintains a taxonomy of items offered for purchase by one or more warehouses 210. For example, the inventory management engine 302 receives an item catalog from a warehouse 210 identifying items offered for purchase by the warehouse 210. From the item catalog, the inventory management engine 302 determines a taxonomy of items offered by the warehouse 210. different levels in the taxonomy providing different levels of specificity about items included in the levels. In various embodiments, the taxonomy identifies a category and associates one or more specific items with the category. For example, a category identifies “milk,” and the taxonomy associates identifiers of different milk items (e.g., milk offered by different brands, milk having one or more different attributes, etc.), with the category. Thus, the taxonomy maintains associations between a category and specific items offered by the warehouse 210 matching the category. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., higher levels include a fewer number of items satisfying a more specific category). The taxonomy may be received from a warehouse 210 in various embodiments. In other embodiments, the inventory management engine 302 applies a trained classification module to an item catalog received from a warehouse 210 to include different items in levels of the taxonomy, so application of the trained classification model associates specific items with categories corresponding to levels within the taxonomy.

Inventory information provided by the inventory management engine 302 may supplement the training datasets 320. Inventory information provided by the inventory management engine 302 may not necessarily include information about the outcome of picking a delivery order associated with the item, whereas the data within the training datasets 320 is structured to include an outcome of picking a delivery order (e.g., if the item in an order was picked or not picked).

The online concierge system 102 also includes an order fulfillment engine 306 which is configured to synthesize and display an ordering interface to each user 204 (for example, via the customer mobile application 206). The order fulfillment engine 306 is also configured to access the inventory database 304 in order to determine which products are available at which warehouse 210. The order fulfillment engine 306 may supplement the product availability information from the inventory database 304 with an item availability predicted by the machine-learned item availability model 316. The order fulfillment engine 306 determines a sale price for each item ordered by a user 204. Prices set by the order fulfillment engine 306 may or may not be identical to in-store prices determined by retailers (which is the price that users 204 and shoppers 208 would pay at the retail warehouses). The order fulfillment engine 306 also facilitates transactions associated with each order. In one embodiment, the order fulfillment engine 306 charges a payment instrument associated with a user 204 when he/she places an order. The order fulfillment engine 306 may transmit payment information to an external payment gateway or payment processor. The order fulfillment engine 306 stores payment and transactional information associated with each order in a transaction records database 308.

In various embodiments, the order fulfillment engine 306 generates and transmits a search interface to a client device 110 of a user 204 for display via the customer mobile application 206. The order fulfillment engine 306 receives a query comprising one or more terms from a user and retrieves items satisfying the query, such as items having descriptive information matching at least a portion of the query. In various embodiments, the order fulfillment engine 306 leverages item embeddings for items to retrieve items based on a received query. For example, the order fulfillment engine 306 generates an embedding for a query and determines measures of similarity between the embedding for the query and item embeddings for various items included in the inventory database 304.

In some embodiments, the order fulfillment engine 306 also shares order details with warehouses 210. For example, after successful fulfillment of an order, the order fulfillment engine 306 may transmit a summary of the order to the appropriate warehouses 210. The summary may indicate the items purchased, the total value of the items in the order, and in some cases, an identity of the shopper 208 and user 204 associated with the transaction of the order. In one embodiment, the order fulfillment engine 306 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 306, which provides detail of all orders which have been processed since the last request.

The order fulfillment engine 306 may interact with a shopper management engine 310, which manages communication with and utilization of shoppers 208. In one embodiment, the shopper management engine 310 receives a new order from the order fulfillment engine 306. The shopper management engine 310 identifies the appropriate warehouse 210 to fulfill the order based on one or more parameters, such as a probability of item availability determined by a machine-learned item availability model 316, the contents of the order, the inventory of the warehouses 210, and the proximity to the delivery location. The shopper management engine 310 then identifies one or more appropriate shoppers 208 to fulfill the order based on one or more parameters, such as the shoppers' proximity to the appropriate warehouse 210 (and/or to the user 204), his/her familiarity level with that particular warehouse 210, and so on. Additionally, the shopper management engine 310 accesses a shopper database 312 which stores information describing each shopper 208, such as his/her name, gender, rating, previous shopping history, and so on.

As part of fulfilling an order, the order fulfillment engine 306 and/or shopper management engine 310 may access a user database 314 which stores information describing each user. This information could include each user's name, address, gender, shopping preferences, favorite items, stored payment instruments, and so on.

In various embodiments, the order fulfillment engine 306 determines whether to delay display of a received order to shoppers 208 for fulfillment by a time interval. In response to determining to delay the received order by a time interval, the order fulfilment engine 306 evaluates orders received after the received order and during the time interval for inclusion in one or more batches that also include the received order. After the time interval, the order fulfillment engine 306 displays the order to one or more shoppers 208 via the shopper mobile application 212; if the order fulfillment engine 306 generated one or more batches including the received order and one or more orders received after the received order and during the time interval, the one or more batches are also displayed to one or more shoppers 208 via the shopper mobile application 212.

### Machine Learning Models

The online concierge system 102 further includes a machine-learned item availability model 316, a modeling engine 318, and training datasets 320. The modeling engine 318 uses the training datasets 320 to generate the machine-learned item availability model 316. The machine-learned item availability model 316 can learn from the training datasets 320, rather than follow only explicitly programmed instructions. The inventory management engine 302, order fulfillment engine 306, and/or shopper management engine 310 can use the machine-learned item availability model 316 to determine a probability that an item is available at a warehouse 210. The machine-learned item availability model 316 may be used to predict item availability for items being displayed to or selected by a user 204 or included in received delivery orders. A single machine-learned item availability model 316 is used to predict the availability of any number of items.

The machine-learned item availability model 316 can be configured to receive, as inputs, information about an item, the warehouse for picking the item, and the time for picking the item. The machine-learned item availability model 316 may be adapted to receive any information that the modeling engine 318 identifies as indicators of item availability. At minimum, the machine-learned item availability model 316 receives information about an item-warehouse pair, such as an item in a delivery order and a warehouse at which the order could be fulfilled. Items stored in the inventory database 304 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 304. Similarly, each warehouse may be identified by a warehouse identifier and stored in a warehouse database along with information about that particular warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 304 and/or warehouse database and provide this extracted information as inputs to the machine-learned item availability model 316.

The machine-learned item availability model 316 contains a set of functions generated by the modeling engine 318 from the training datasets 320 that relate the item, warehouse, and timing information, and/or any other relevant inputs, to the probability that the item is available at a warehouse. Thus, for a given item-warehouse pair, the machine-learned item availability model 316 outputs a probability that the item is available at the warehouse. The machine-learned item availability model 316 constructs the relationship between the input item-warehouse pair, timing, and/or any other inputs and an availability probability (also referred to as “availability”) that is generic enough to apply to any number of different item-warehouse pairs. In some embodiments, the probability output by the machine-learned item availability model 316 includes a confidence score. The confidence score may be the error or uncertainty score of the output availability probability and may be calculated using any standard statistical error measurement. In some examples, the confidence score is based, in part, on whether the item-warehouse pair availability prediction was accurate for previous delivery orders (e.g., if the item was predicted to be available at the warehouse and not found by the shopper or predicted to be unavailable but found by the shopper). In some examples, the confidence score is based, in part, on the age of the data for the item, e.g., if availability information has been received within the past hour, or the past day. The set of functions of the machine-learned item availability model 316 may be updated and adapted following retraining with new training datasets 320. The machine-learned item availability model 316 may be any machine learning model, such as a neural network, boosted tree, gradient boosted tree or random forest model. In some examples, the machine-learned item availability model 316 is generated from the XGBoost algorithm.

The item probability generated by the machine-learned item availability model 316 may be used to determine instructions delivered to the user 204 and/or shopper 208, as described in further detail below.

The training datasets 320 relate a variety of different factors to known item availabilities from the outcomes of previous delivery orders (e.g., if an item was previously found or previously unavailable). The training datasets 320 include the items included in previous delivery orders, whether the items in the previous delivery orders were picked, warehouses associated with the previous delivery orders, and a variety of characteristics associated with each of the items (which may be obtained from the inventory database 304). Each piece of data in the training datasets 320 includes the outcome of a previous delivery order (e.g., if the item was picked or not). The item characteristics may be determined by the machine-learned item availability model 316 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 316 may weight these factors differently, where the weights are a result of a “learning” or training process on the training datasets 320. The training datasets 320 are very large datasets taken across a wide cross section of warehouses, shoppers, items, warehouses, delivery orders, times, and item characteristics. The training datasets 320 are large enough to provide a mapping from an item in an order to a probability that the item is available at a warehouse. In addition to previous delivery orders, the training datasets 320 may be supplemented by inventory information provided by the inventory management engine 302. In some examples, the training datasets 320 are historic delivery order information used to train the machine-learned item availability model 316, whereas the inventory information stored in the inventory database 304 include factors input into the machine-learned item availability model 316 to determine an item availability for an item in a newly received delivery order. In some examples, the modeling engine 318 may evaluate the training datasets 320 to compare a single item's availability across multiple warehouses to determine if an item is chronically unavailable. This may indicate that an item is no longer manufactured. The modeling engine 318 may query a warehouse 210 through the inventory management engine 302 for updated item information on these identified items.

### Machine Learning Factors

The training datasets 320 include a time associated with previous delivery orders. In some embodiments, the training datasets 320 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 320 include a day of the week previous delivery orders were placed. The day of the week may impact item availability since popular shopping days may have reduced inventory of items or restocking shipments may be received on particular days. In some embodiments, training datasets 320 include a time interval since an item was previously picked in a previous delivery order. If an item has recently been picked at a warehouse, this may increase the probability that it is still available. If there has been a long time interval since an item has been picked, this may indicate that the probability it is available for subsequent orders is low or uncertain. In some embodiments, training datasets 320 include a time interval since an item was not found in a previous delivery order. If there has been a short time interval since an item was not found, this may indicate that there is a low probability that the item is available in subsequent delivery orders. And conversely, if there has been a long time interval since an item was not found, this may indicate that the item may have been restocked and is available for subsequent delivery orders. In some examples, training datasets 320 may also include a rate at which an item is typically found by a shopper at a warehouse, a number of days since inventory information about the item was last received from the inventory management engine 302, a number of times an item was not found in a previous week, or any number of additional rate or time information. The relationships between this time information and item availability are determined by the modeling engine 318 training a machine learning model with the training datasets 320, producing the machine-learned item availability model 316.

The training datasets 320 include item characteristics. In some examples, the item characteristics include a department associated with the item. For example, if the item is yogurt, it is associated with the dairy department. The department may be bakery, beverage, nonfood and pharmacy, produce and floral, deli, prepared foods, meat, seafood, dairy, or any other categorization of items used by the warehouse. The department associated with an item may affect item availability, since different departments have different item turnover rates and inventory levels. In some examples, the item characteristics include an aisle of a particular warehouse associated with the item. The aisle of the warehouse may affect item availability since different aisles of a warehouse may be more frequently re-stocked than others. Additionally, or alternatively, the item characteristics include an item popularity score. The item popularity score for an item may be proportional to the number of received delivery orders received that include the item. An alternative or additional item popularity score may be provided by a retailer through the inventory management engine 302. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 318 training a machine learning model with the training datasets 320, producing the machine-learned item availability model 316.

The training datasets 320 may include additional item characteristics that affect the item availability and can therefore be used to build the machine-learned item availability model 316 relating the delivery order for an item to its predicted availability. The training datasets 320 may be periodically updated with recent previous delivery orders. The training datasets 320 may be updated with item availability information provided directly from shoppers 208. Following updating of the training datasets 320, a modeling engine 318 may retrain a model with the updated training datasets 320 and produce a new machine-learned item availability model 316.

### Promoted Content

The order fulfillment engine 306 may select and provide user interface elements and other components to be displayed to users and shoppers. As discussed above, users may interact with elements for selecting items to be included as part of an order. The order fulfillment engine 306 may select items to be presented to the user based on various factors and attributes, such as items searched for by a user, items related to items searched for by the user, items related to items in a user's order (e.g., a user's current cart), among other factors. In some instances, items may be presented to users based on content campaigns in which the relative prioritization of items may be affected by a budget and/or a bid of the respective content campaigns.

As the display space on a user's device is limited, a bid for each content campaign may be used as a mechanism to automatically allow the respective campaigns to compete for selection in the display space for the respective content of the campaign. Stated another way, selection of one campaign's content typically prevents selection of another campaign's content, such that the prioritization of presenting one campaign content thus naturally “competes” with prioritization of presenting another's. The campaigns may be associated with items of interest to the user, such as individual items that may be added to a user's order, or may be other types of content or information that may be of value to present to the user and thus compete for limited space on the user's display. The particular information of the campaign that is provided to the user is referred to as a content item. As examples, a content item may include an image, text, a description (e.g., of an item), interactable elements (e.g., to add a related item to a user's order), a link to an item (e.g., a “click”), and so forth. Thus, the content items with respect to content presented in a content campaign may include content items that may be added to an order and may also relate to other information or content that is not a direct presentation of an item offered as part of an order, such as other supplemental information or information that may be beneficial for a user. As examples, content items for prioritization with the content campaigns may include informational items related to additional features or aspects of the online concierge system 102 (e.g., information for assisting new users in navigating the system, suggestions for a user to try additional features or aspects, “how-to” informational tips for the online system, offers for a user to subscribe to additional optional features, etc.), suggested uses or complementary items for items in a user's cart (e.g., for food items, suggested recipes or food/drink pairings), and so forth.

To select a content item, the campaigns may compete with each other for placement by offering a portion of the presentation budget (e.g., a bid) that may compete with other content campaigns, such that the content campaign offering the highest value may reflect the highest prioritization for an item to be presented. For convenience, the portion offered by a campaign is referred to as a “bid.” However, the budget may not represent real currency and may represent other priorities competing for limited area on a user's display, such as in the examples above. In some circumstances, the content campaigns may include sponsored content, such that the bid represents a value from a promoter of a particular item for presenting that item to the user; in other circumstances, the items may represent the prioritization of items beneficial to effective operations of the system, warehouses, items of interest to users (e.g., suggested items to complement existing items), based on excess warehouse stock, etc.

The online concierge system 102 may perform an auction to select a winning content campaign based on the various bids of the competing content campaigns. In some embodiments, the items may be selected based on a second-price auction. When a particular content campaign wins the auction, a portion of the content campaign budget is used, and the promoted content associated with the content campaign is presented to the user. Different content campaigns may also be eligible to be provided to different users and orders based on various criteria, such as the warehouse fulfilling the order, items in the user's cart, the user's historical purchases, etc.

The content campaigns may be stored in a campaign database 324. The campaign database 324 may include currently active content campaigns along with historical data regarding performance of previous content campaigns.

As the user interacts with the online concierge system 102 (e.g., through user interface displays such as ordering interfaces or search interfaces provided by the order fulfillment engine 306), the online concierge system 102 (e.g., as a component of the order fulfillment engine 306) may identify locations, also termed “positions” or “slots” in which promoted content may be placed for display to the user. The individual slots may have different sizes, shapes, and other characteristics that may vary in different implementations.

An auction may be performed for each slot, in which the different types of slots and/or characteristics may represent different types of auctions for different circumstances in which the selected content will appear. For example, when a user searches for an item by entering a search query, the terms in the search query may be used as keywords for a keyword auction, in which keywords may be used to determine relevant content campaigns. Similarly, when a user navigates to a page for a particular product, a slot on the product page may be filled by a product auction, in which the particular product is used to determine relevant content campaigns. As another example, when a user navigates to a page describing a category of products, a category auction may be used, in which the category is used to determine the relevant content campaigns. As such, each of these circumstances may represent a different type or modality for the circumstance in which the winning content of the auction will be presented.

The information used by a campaign manager 322 for determining whether to participate is referred to as an “auction context.” The auction context may indicate at least an auction type (e.g., this auction relates to a keyword search for “milk”) and may include additional characteristics describing an auction opportunity. The auction context generally describes additional contextual information that may be used to evaluate a content campaign's participation in a particular auction. In addition to the auction type and relevant information about the auction type (e.g., describing the search query or the item page viewed by a user), auction context may also describe, for example, the size and position of the slot, other content presented near the slot (e.g., the contents of the search results or other items appearing nearby), information about the user's cart (e.g., other items currently being considered for purchase with this order), user characteristics (e.g., a user's historical orders or an embedding describing the user), and any other contextual information (e.g., time of day, etc.).

In some circumstances, although referred to as different “auction types” as generally separate or orthogonal circumstances (e.g., targeted by separate auction types), in some embodiments, the auction context may include information related to multiple auction types. For example, a user may perform an item search and also select a specific category for the search, such as selecting a “snacks” category and then entering a search query for “corn chips.” In this example, the auction context may indicate an auction type for the category (“snacks”) in addition to an auction type for the search keywords (“corn chips”).

In various embodiments, each content campaign may be used for one or more different auction types (e.g., for placement in different types of slots with different characteristics). For example, a content campaign may compete based on keywords, particular products/items, categories, and so forth. Each auction type may have a different budget and/or bid that the campaign uses to compete in auctions when an auction of the respective type occurs.

In addition, in some embodiments, the online concierge system 102 includes a campaign generation module 326 that assists a sponsor in the creation of a content campaign. In many circumstances, selecting parameters for individual campaigns may be a complex task for a sponsor; while the additional context of particular auction types may provide an increased ability to determine the circumstances in which the campaign's content is provided to promote the promoted item, it may introduce complexity of requiring a sponsor to determine particular parameters for each type (e.g., the particular keywords, categories, or products relevant to the campaign). The campaign generation module 326 may automatically generate such parameters for initiating a campaign and manage interfaces and other interactions with a user associated with a sponsor for managing campaigns.

The sponsor may interact with one or more user interfaces to provide relevant information about initiating and managing the campaign. The campaign content includes information that may be used for the content of the campaigns, such as the specific content to be provided when a campaign successfully wins an auction, the target item promoted by the campaign (e.g., an identifier of a target item, a reference or link to the target item, etc.), and so forth. Additional parameters may include control information used for controlling presentation of the campaigns, such as the total available budget for the campaign, duration of the campaign, and one or more objectives to be optimized for the campaign.

In some embodiments, the campaign generation module 326 generates campaign parameters for individual campaigns. The particular auction types for an individual campaign may be automatically determined by the campaign generation module 326 or may be designated by the sponsor. The campaign parameters may be used to describe, for example, eligibility conditions indicating in what auction contexts the campaign is eligible to participate and a bid amount for the campaign. In some embodiments, the campaigns may include different sets of eligibility conditions that may each be associated with different bid amounts. For example, a keyword campaign may have eligibility criteria using one keyword with one bid amount, and another keyword using another bid amount.

Eligibility conditions for the respective auction types may differ for the different auction types and may be particular to each auction type. For example, eligibility conditions for a keyword campaign relating to a keyword auction indicates one or more keywords, while the eligibility conditions for a product campaign relating to a product auction indicates one or more products, etc. For example, for a campaign request for a target item of a brand of ice cream, eligibility conditions for the keyword campaign may include keywords “frozen,” “ice cream,” “frozen yogurt,” and “popsicle,” such that a keyword auction having one of these keywords is eligible for a keyword campaign to offer a bid. Similarly, a product campaign may include one or more products (e.g., individual items) as eligibility conditions, such as a cake, whipped cream, or another ice cream item, such that a user viewing one of these product pages is eligible for the product campaign. A category campaign may likewise indicate one or more categories as parameters to be matched with an auction context for a user viewing one of these categories or otherwise associated with the matching categories (e.g., high frequency of purchases from the category, an order includes products from that category, and so forth). The eligibility conditions may also include additional conditions unrelated to the auction type, such as any additional characteristic of the auction context (e.g., other items in a user's cart, or other elements on the page that are being presented to the user).

The particular parameters for each campaign may be provided by the sponsor or may be generated by the campaign generation module 326, or a combination of these. When the parameters are generated by the campaign generation module 326, the generated parameters may be sent for approval by the sponsor before being used in the campaign.

To automatically generate the campaign parameters, the campaign generation module 326 may use information from the sponsor related to the campaign along with information from a campaign database 324 (e.g., historical performance of campaigns) to determine parameters that may be effective for each campaign.

The bids for each campaign may be automatically generated by the campaign generation module 326 based on one or more objectives from the sponsor. Higher bid amounts may mean that the campaign more often wins an auction, but at the expense of drawing down the budget more quickly. If a bid amount is too low, the campaign may no longer successfully win auctions of its type. As such, the bid amount for a particular campaign may be set, automatically or by the campaign sponsor, at a level that permits the campaign to win that auction type. The bid amount may be based on historical bid amounts by the sponsor, e.g., based on previous campaigns of the sponsor. In addition, the bid amount may be set based on average bid amounts at which the auction type (e.g., a keyword auction) clears (e.g., amounts actually paid when that auction type is completed). The bid amounts, in some embodiments, may also be modified during execution of the campaign to increase or decrease the frequency that the campaign successfully wins the auction, and thus also affects the spending rate of the campaign.

The objectives of the sponsor may also be used to determine the bid amount. In particular, a ratio of the bid (expected spending rate or other price paid) relative to a value or frequency of the objective may be determined. The ratio may also be expressed as the objective relative to the bid/value paid. The ratio thus indicates a return of the spending/bid relative to the objective. The bid (and/or expected spending rate or other price paid) may be prevented from exceeding a value that would indicate an insufficient yield ratio below a threshold. The insufficient yield may be expressed as a threshold, such that insufficient return on the objective reduces the bid amount. This may prevent the campaigns from bidding highly to win auctions for which there is insufficient benefit. The objectives, in some embodiments, may be the presentation of the content to a user (i.e., an impression). In these examples, the objective may occur each time the campaign wins an auction. In other examples, the objective may be related to further actions performed by users after the user is presented with promoted content. For example, a user interaction with the promoted content (e.g., clicking the content to view further information or a link to another page), the user viewing a promoted item, the user adding the promoted item to a cart, etc. For these actions, winning the auction may not itself define success relative to the objective, and these actions may vary in how often they occur after participating in or winning an auction.

The campaign generation module 326 may estimate a frequency of the objective for a content campaign based on current or projected conditions (e.g., the frequency of auctions meeting the eligibility conditions) along with the performance of prior campaigns (e.g., relating to the same item or sponsor; or campaigns having other similarities to the evaluated campaign). In one embodiment, the estimated frequency is evaluated to determine a ratio of the objective with respect to the bid. The estimated frequency may also be combined with a value of the objective to determine an expected value for the campaign when it wins an auction. In some embodiments, the bids may thus be automatically set and the ratio may be used to prevent the bid value from exceeding a value that would ineffectively spend the budget relative to the campaign objective. This may be because each set of eligibility criteria may yield different results with respect to the objective (e.g., different interaction rates for the desired action). For example, each keyword (or a group of keywords) in the keyword campaign may be associated with different bid amounts-a keyword that has higher interaction rates may have a higher bid amount than another keyword with relatively lower interaction rates, while each having a similar ratio.

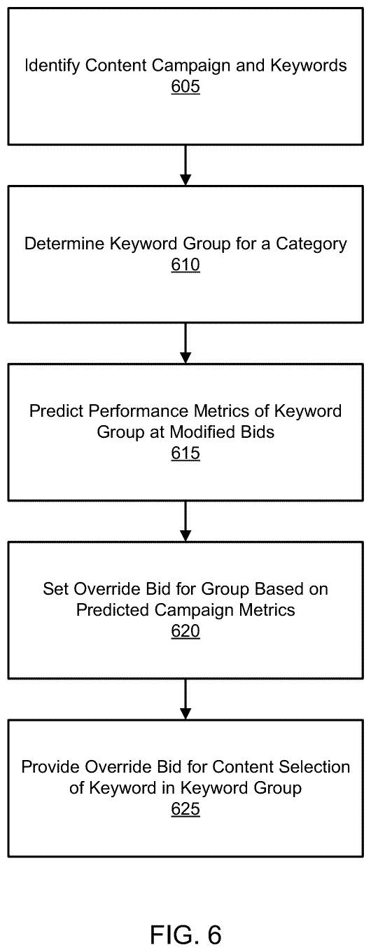

Keyword campaigns may have a large number of keywords that may make selection of bids for different keywords difficult to manage on an individual keyword basis. To improve setting bids for keywords, the campaign generation module 326 may automatically group keywords and set a particular bid for the group of keywords as discussed with respect to FIGS. 5-7B. Various performance metrics (e.g., which may relate to different campaign objectives) may be calculated for the keyword groups at different bid values, and used to aid in setting the bid for the keyword group.

In addition to the bid amount for a campaign, the campaign generation module 326 may also determine parameters for the eligibility conditions for the campaigns. In some embodiments, the eligibility conditions for a campaign are determined first, and then the respective bids for the campaign (or separate eligibility criteria within an auction type) are determined. The campaign generation module 326 may thus generate a set of keywords for a keyword campaign, products for a product campaign, or categories for a category campaign that describe when the campaigns may be eligible to participate in an auction opportunity. The eligibility conditions may be based on information in the sponsor along with information from prior campaigns and other relevant information relating different concepts, products, and terms, from the campaign database 324.

The keywords for a keyword campaign may be automatically generated based, for example, on the promoted item for the content campaign along with a description of the item and any additional keywords provided by the sponsor. The keywords may be based on word embeddings of the target item based on historical search terms, in which users select the target item as a result, descriptions of co-purchased items, and so forth. In one embodiment, the keywords are based on a set of seed keywords (e.g., from the sponsor or the item description) and user engagement metrics, for example as discussed in U.S. patent application Ser. No. 17/899,441, filed Aug. 30, 2022, the contents of which are hereby incorporated by reference.

Similarly, the products for a product campaign may be automatically generated based, e.g., on the promoted item for the content campaign and other similar, complementary, or co-related items. The products may be determined, for example, based on items co-added to a user's cart (e.g., as historical data), items selected as substitutes for other items, similarity of item descriptions (e.g., based on word embeddings of the respective descriptions), other items on a page associated with the target item, and so forth. The sponsor may also provide products for the product campaign or excluded products that may not be included in the product campaign.

To generate categories for a category campaign, the campaign generation module 326 may identify one or more categories of the target item and select categories for the category campaign that are related to the identified categories. The related categories may be determined, for example, by categories on an adjacent taxonomy branch as the category of the item, or categories at a higher (more general) level than the category of the item, among other approaches. The categories for an item may also be determined based on categories used for historical campaigns in the campaign database 324 for the item or similar items (e.g., as may be determined for a product campaign).

Finally, the content campaigns, execution of auctions, management of campaigns, etc., may be implemented in different configurations and by different systems than as shown in FIG. 3. For example, in some embodiments the campaign database 324, campaign manager 322, and campaign generation module 326 may be implemented by separate systems from the online concierge system 102, such as a third-party system 130. In these circumstances, the online concierge system 102 may provide information describing the available auction slot to the third-party system 130, which may determine content campaigns competing in the auction, execute the auction, and provide the promoted content of a winning campaign to the online concierge system 102 in response.

### Customer Mobile Application

FIG. 4A is a diagram of the customer mobile application (CMA) 206, according to one or more embodiments. The CMA 206 includes an ordering interface 402, which provides an interactive interface with which a user 204 can browse through and select products and place an order. The CMA 206 also includes a system communication interface 404 which, among other functions, receives inventory information from the online concierge system 102 and transmits order information to the online concierge system 102. The CMA 206 also includes a preferences management interface 406 which allows the user 204 to manage basic information associated with his/her account, such as his/her home address and payment instruments. The preferences management interface 406 may also allow the user to manage other details such as his/her favorite or preferred warehouses 210, preferred delivery times, special instructions for delivery, and so on.

### Shopper Mobile Application

FIG. 4B is a diagram of the shopper mobile application (SMA) 212, according to one or more embodiments. The SMA 212 includes a barcode scanning module 420, which allows a shopper 208 to scan an item at a warehouse 210 (such as a can of soup on the shelf at a grocery store). The barcode scanning module 420 may also include an interactive interface which allows the shopper 208 to manually enter information describing an item (such as its serial number, SKU, quantity and/or weight) if a barcode is not available to be scanned. The SMA 212 also includes a basket manager 422, which maintains a running record of items collected by the shopper 208 for purchase at a warehouse 210. This running record of items is commonly known as a “basket.” In one embodiment, the barcode scanning module 420 transmits information describing each item (such as its cost, quantity, weight, etc.) to the basket manager 422, which updates its basket accordingly. The SMA 212 also includes a system communication interface 424 which interacts with the online concierge system 102. For example, the system communication interface 424 receives an order from the online concierge system 102 and transmits the contents of a basket of items to the online concierge system 102. The SMA 212 also includes an image encoder 426, which encodes the contents of a basket into an image. For example, the image encoder 426 may encode a basket of goods (with an identification of each item) into a quick response (QR) code which can then be scanned by an employee of the warehouse 210 at check-out.

### Keyword Bid Groups

FIG. 5 shows an example of keyword grouping and group bid setting for a keyword campaign 500, according to one or more embodiments. As discussed above, a keyword campaign 500 may be created with a set of keywords 505 to be targeted by the campaign. The keywords 505 may thus represent all keywords for which the keyword campaign 500 may bid. The keyword campaign 500 may include promoted content (e.g., the content to be displayed when the keyword campaign wins an auction) as well as a campaign-level bid describing a default bid for the keywords in the campaign. When the campaign is active and when one of the keywords 505 is present in a keyword auction opportunity 530, the campaign may use an associated bid of the keyword for participating in the auction. If the campaign wins the auction, the promoted content is provided for display to a user. The example keyword campaign shown here illustrates a keyword campaign 500 for a brand of vanilla nut ice cream as an item available for addition to an order by a user.

FIG. 5 shows an example of campaign creation (or modification) and keyword grouping to set bids for an active content campaign 520 used to respond to a keyword auction opportunity 530. Keyword groups 510A-C are generated that each include a subset of the keywords 505, each of which may be set a respective override bid 515A-C. As discussed further below, the keywords may be grouped automatically or by custom selection of a user (e.g., a user affiliated with the campaign sponsor). The automatic grouping may be based on a property (or predicted property) of a keyword, such as its relevance, popularity, likelihood of bid modification (increase or decrease), and so forth. In this example, a first group of keywords is grouped automatically based on relevance to the sponsored content item, forming a relevance keyword bid group 510A, and a second group of keywords is grouped automatically based on a likelihood the sponsor will reduce the bid for the group, forming a negative keyword bid group 510B. The keywords may be grouped automatically on various bases as further discussed below. In this example, a custom keyword bid group 510C is also specified by the user/sponsor.

Each of the keyword groups 510A-C may then be set 515A-C to a respective override bid. The override bid is a different bid for a keyword and/or keyword group that differs from the campaign-level bid. The campaign-level bid may thus operate as a “default” or “standard” bid for the keywords 505 of the keyword campaign 500. When an override bid is set for a keyword (e.g., via a keyword group), the override bid operates as a replacement or override of the campaign-level bid. The keywords and the respective bids (e.g., an override bid or a campaign-level bid) may be stored as an active content campaign 520, such that when a keyword auction opportunity 530 occurs, if a keyword of the active content campaign 520 matches a keyword of the keyword auction opportunity 530, the active content campaign 520 competes in the auction with the associated bid. In this example, the override bid set 515A-C for each keyword group 510A-C is reflected in the active content campaign 520. The campaign keywords 505 that do not have an override bid may be associated with the campaign-level bid, in this example $1.00. In the example shown in FIG. 5, the keyword auction opportunity 530 specifies the term “vanilla nut,” which has a match in the active content campaign 520 with an override bid of $2.00, such that the campaign may compete with the associated bid as a campaign bid 540. In this example, the keyword “vanilla nut” had its bid set based on its membership in a relevant keyword bid group 510A.

Although five keywords 505 are shown in FIG. 5, in practice, the number of keywords 505 that may be used may include hundreds, thousands, or more individual keywords. Such keywords may include individual terms, combinations of terms, and other variations of individual tokens. By providing an improved means for automatically grouping the keywords 505 and setting an override bid, an online system (such as the online concierge system 102) may improve the way sponsors create and manage their campaigns, improving the ability of sponsors to use campaigns with a large number of keywords (enabling targeting of a large number and variety of keyword auctions) while also enabling focused customization of bids for keyword groups.

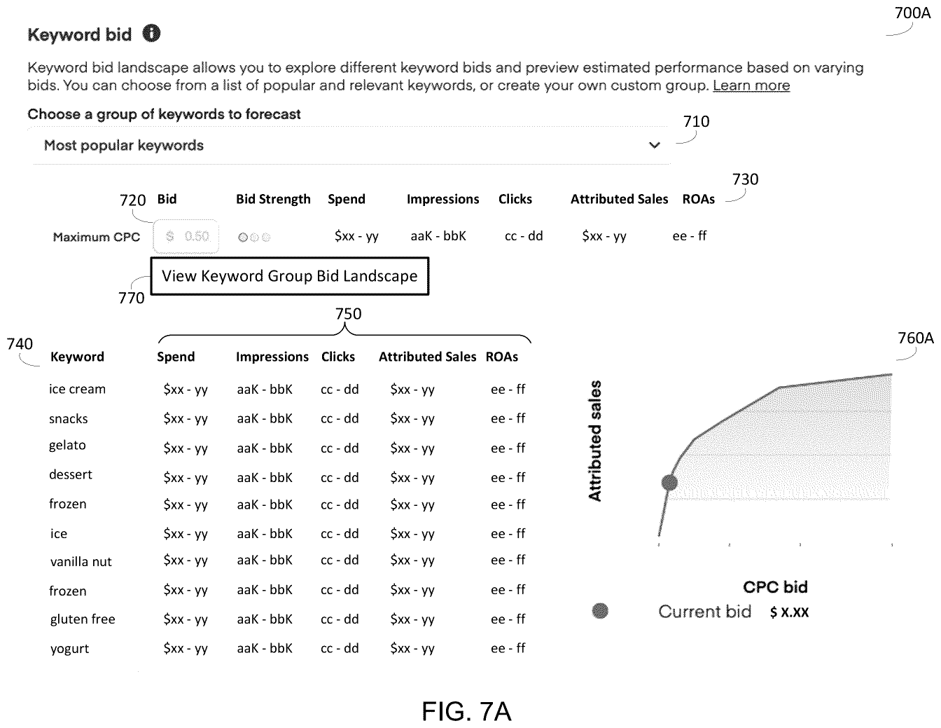

FIG. 6 is an example flowchart for a method related to content campaigns with different bids for keyword groups, according to one or more embodiments. In various embodiments, the method includes different or additional steps than those described in conjunction with FIG. 6. Further, in some embodiments, the steps of the method may be performed in different orders than the order described in conjunction with FIG. 6. The method described in conjunction with FIG. 6 may be carried out by the online concierge system 102 in various embodiments, while in other embodiments, the steps of the method are performed by any online system capable of retrieving items.

As a general overview, the method includes identifying 605 keywords for the content campaign, automatically determining 610 keyword groups for a category, generating 615 performance metrics of the keyword groups at one or more modified bids (e.g., different from the campaign-level bid), and setting 620 an override bid for the keywords in the group based on the performance metrics. When the campaign is active, when a keyword opportunity occurs for a keyword in the keyword group, the override bid is provided 625 for the keyword to compete for selection for presentation to the user. This process may be used to set override bids before beginning a content campaign, or may be used during operation of a campaign to modify bids during operation.

In further detail, the keywords identified 605 for the content campaign are the keywords that may be used for selection of the keyword campaign (e.g., keywords 505) for a keyword auction. The set of identified keywords are thus the keywords that may be used to target the content campaign, and for an operating campaign may be all keywords currently associated with targeting for the campaign. In the campaign creation process (or to modify an operating campaign), the keywords for a campaign may be determined in a variety of ways. In some embodiments, the keywords 505 for a campaign may be automatically determined, based e.g., on the sponsor, the item, the item's description, historical campaigns, and so forth, as also noted above with respect to FIG. 3. These keywords may include, for example, keywords associated with embeddings similar to an embedding of a promoted item (e.g., based on the item's name, description, etc.), an expansion of a set of seed keywords as noted above, or with other techniques. Additional keywords may also be generated as variations of keywords, for example, permuting or modifying keywords to account for errors or other common mistakes. For example, a keyword of “dessert” may be commonly misspelled as “desert.” To account for this possible error, a campaign may include permutations and variations of various keywords; in this example, the keyword “desert” may be added based on the keyword “dessert” in the campaign. In addition, or as an alternative, the sponsor of the campaign (e.g., a user operating on behalf of the sponsor) may provide keywords and/or modify automatically generated keywords.

Based on the set of keywords for the campaign (e.g., campaign keywords), the online system may automatically group a subset of the keywords into a keyword group for setting an override bid for the keywords in the keyword group. To do so, the keyword group is determined 610 based on category membership (or predicted category membership) of the keywords. The keyword groups may be determined in different ways in different embodiments. The categories may be selected for different characteristics and/or properties of the keywords, such as the most relevant, most popular, relation to a brand associated with the sponsor (or a sponsor's competitor), and so forth. In addition, the keyword groups may also be based on the likelihood that the keyword may have an increased (positive) or lowered (negative) override bid relative to the campaign-level bid. As such, in some examples, the keywords may be grouped with respect to a category (e.g., popularity) and the likelihood of an increased or decreased override bid. In these examples, two different keyword groups may be formed for keywords in a given category: one keyword group for keywords in the category associated with a likelihood for an increased override bid and another keyword group for keywords in the category associated with a likelihood for a decreased override bid. This may permit the campaign to automatically group and distinguish popular keywords that may be of particular interest to the sponsor (i.e., reflected in likelihood of an increased bid) from popular keywords that may be of decreased interest to the sponsor (i.e. with a decreased bid). In general, the keywords may be evaluated by scoring each keyword with respect to membership in the category, and keywords may be selected for the keyword group based on the scoring.

The particular methodologies for scoring the keywords and automatically grouping them may vary in different embodiments, and in some embodiments, may include other approaches than those specifically discussed here (e.g., different from scoring with respect to the category). For example, in some embodiments, one or more keywords may belong to one or more categorization schemes or taxonomies that may form the basis for a keyword group category. In additional embodiments, keywords may be grouped based on latent characteristics, for example with an unsupervised clustering algorithm (e.g., based on keyword embeddings).

In one example, the keywords may be grouped based on historical data and/or computer model predictions, each of which may vary depending on the particular category. As some examples, the categories may relate to popularity, relevance, brand terms, or seed keyword similarity, among others. Each keyword may be scored with respect to membership in the category and used to select the subset of the campaign keywords for the keyword group.

As discussed further below, in some embodiments, the grouping is based on the category as well as the likelihood that the sponsor will assign an override bid to that keyword. In some embodiments, the category and override bid are scored independently and combined. In other embodiments, a combined model may be used to incorporate both the category membership and override bid in a single output prediction.

For example, the “popular” category may refer to items that are relatively more likely to be keywords that appear in keyword searches by users. Keyword popularity may be determined for individual keywords based on the frequency that keyword auctions including that particular keyword occur or are expected to occur during the duration of the campaign. That is, keyword popularity may measure a frequency that incoming search queries will include the keyword. The popularity may be predictive of the frequency that a keyword will appear in future keyword auctions, which may itself be based on historical user search activity. The popularity may be scored for each keyword as a predicted number of times the keyword will appear, as a likelihood that the keyword will appear in a frequency range, or a likelihood that the keyword appears with a frequency higher than a threshold frequency. These predictions may be performed by a trained computer model based on prior keyword auction opportunities (e.g., user searches including the keyword).

In one embodiment, popular keywords are scored with a trained binary classification model (e.g., a neural network or a logistic regression) with respect to whether the keyword will be searched above a threshold frequency (e.g., a sufficient volume) within an upcoming time range (e.g., an hour, day, week, or month). Input features may include historical auction frequency (e.g., keyword search volume for the keyword at one or more historical time intervals) and may also include features related to content campaigns and other data, such as historical campaign objectives (e.g., historical click-through rates for campaigns with a particular keyword), keyword embeddings, campaign and brand categories, product embeddings (of a sponsored campaign item), product category embeddings, and so forth. The output of the trained binary classification model may be used as a score for the popularity category.

In another example, keyword relevance may be determined based on the relevance of a keyword to relevance to received search queries, the content campaign, (e.g., a content item promoted in the campaign), or to a seed keyword. This relevance may be determined by one or more computer models and/or one or more embeddings. For example, in one embodiment, the keyword relevance with respect to likely search queries may be determined based on the relevance of a keyword to incoming search queries as a whole (i.e., in addition to the entire search query). For example, some keywords, such as “ice” may have a match to a large number of search queries for which “ice,” alone, varies significantly in relevance. For example, while “ice” may appear alone in a search for a user searching for cubed ice, the keyword “ice” may also match searches for “ice cream,” “iced latte,” “ice pop,” and so forth. As such, the keyword may be evaluated for its relevance with respect to the search query as a whole (i.e., when the keyword has a match to a keyword auction opportunity, a measure of how relevant the matching keyword is to the entire search query). The keyword relevance for historical auctions may be determined, for example, based on keyword and search query embeddings (e.g., measured by a relevance or similarity metric, such as cosine similarity or Euclidean distance). A computer model may predict a category score for grouping keywords based on a set of input features such as those noted above to predict the likely relevance of the keyword to a search query.

In addition to search query relevance, a relevance category may be based on the relevance of a keyword to the content campaign. For example, the content campaign may be represented by an embedding that characterizes the campaign content and/or the item promoted by the campaign (e.g., the description of the item). In one embodiment, each keyword's category score for relevance to the campaign may be determined with a relevance function (e.g., cosine similarity or a distance function) between a keyword embedding and the campaign embedding. In additional embodiments, a computer model may be used to determine the category score, which may include features and be trained with respect to campaign relevance.

An additional category are keywords related to a brand associated with a campaign sponsor. A brand may represent a name or other term related to a source, origin, or entity responsible for the production or creation of an item. The brand category may be used to automatically group keywords that may be associated with a brand of the campaign. The brand may be predicted for the sponsor of the campaign based on brands associated with the item and the sponsor and generate a category score based on the likelihood a keyword may be a brand. The brand matching may be based on brands associated with the campaign and the promoted item and fuzzy-matching of keywords with respect to the brands (e.g., for keywords which may be misspellings of the brand).

In addition to generating a category score for the respective category, a computer model may also predict whether a keyword is likely to have its bid modified by a sponsor based on prior campaigns (e.g., in which keywords of the campaign were associated with different bids in the campaign). The prior campaigns used to train the model may include prior campaigns of the sponsor, and in some embodiments may include prior campaigns from other sponsors. In some embodiments, a different model is used/learned for each category; in other embodiments, a single computer model may be trained for several categories simultaneously. In some campaign training data, the campaigns may not have a designated “campaign-level” bid, such that each keyword is associated with a particular bid without designating as a default or an override. In these examples, the keyword bids may be characterized for input to the training model. For example, the average, mean, or median (or another statistical measure) of the keyword bids may be treated as the “campaign-level” bid, such that keywords associated with higher bids are considered to have override bids above the campaign-level bid, and keywords associated with lower bids are considered to have override bids below the campaign-level bid. The computer model predicting the likelihood of an override bid may be structured differently in different embodiments; in one embodiment, the model is a classifier in which the classes indicate a modified bid or an unmodified bid. In another example, the computer model may predict whether the keyword is associated with an override bid above or below the campaign-level bid. In one embodiment, one computer model may be used to predict whether a keyword will be associated with an override bid higher than the campaign-level bid (e.g., a positive override) and another computer model may be used to predict whether the keyword will be associated with an override bid lower than the campaign-level bid (e.g., a negative override).

As such, in some embodiments, for a given category, a category score and an override score may be generated for each campaign keyword. In some embodiments, the category score alone is used to select the keyword group for the category. In one embodiment, the keywords may be ranked by the category score, such that the keywords having scores above a threshold, or a number of highest-scoring keywords (e.g., the top 10) are selected as the keywords for the keyword group of the category.

In another embodiment, the override score may be used to further select which keywords are included in the category group. The combination of the category score and override score for selecting the keyword group of the category group may be performed in many different ways in different embodiments. For example, keywords with an insufficient override score (i.e., predicted to have a chance of an overridden bid below a threshold), in one or more embodiments, are filtered from the set of campaign keywords for the category, and the remaining keywords of the category (predicted to have a chance of an overridden bid above the threshold) may be used to generate the keyword group for the category. In other embodiments, the category score and override score may be combined as a weighted combination before selection. In further examples, the selected keyword group may be based on whether the override is predicted to be positive or negative (e.g., keywords predicted to be in the category and predicted to be overridden with an increased bid). This may assist users in grouping keywords that are likely to receive similar treatment by the sponsor, for example to automatically form one group of “popular” keywords that are likely to have a higher override bid and another group of “popular” keywords that are likely to have a lower override bid, allowing automatic grouping of different categories likely to receive different treatment by the sponsor.

In another embodiment, rather than discrete scores for the category and the likelihood of an override bid, one hybrid score may be generated. For example, a single computer model may be used to predict category membership in conjunction with likelihood of a bid override. That is, the computer model may be trained to predict the likelihood of a keyword belonging to a category and having an override bid. For example, a popularity category may predict the combined outcome of a keyword's bid being overridden and the keyword being searched above a threshold frequency in an upcoming time period (e.g., the next week). In this embodiment, the computer model may be a classification model (e.g., a binary classification), such as a logistic regression, and may include input features such as historical auction frequency (e.g., keyword search volume for the keyword at one or more historical time intervals), features related to content campaigns, historical campaign objectives (e.g., historical click-through rates for campaigns with the keyword), keyword embeddings, campaign and brand categories, product embeddings (of the sponsored campaign item), product category embeddings, and so forth. To generate the keyword groups, each campaign keyword may be processed to generate an associated hybrid score. The keywords may be ranked based on the hybrid score and a number of the highest-ranking keywords and/or keywords above a threshold score are selected for the keyword group. In some embodiments, different computer models may be used for each category in combination with whether the override bid is predicted to be higher or lower than the campaign-level bid. For example, one computer model for a category may jointly predict category membership and an increased override bid (i.e., a model that jointly predicts category membership and a higher bid than the campaign-level bid); while another computer model may jointly predict category membership and a decreased override bid.

After determining the keywords in a keyword group, performance metrics may be generated 615 for the keywords at one or more modified bids, which differ from campaign-level bids. The modified bids may be used to evaluate the effects of setting an override bid to the respective values of the modified bids. The modified bids may be selected in any suitable means, such as values that differ from the campaign-level bid by a specified amount, a percentage, based on clearing prices for auctions of the keywords in the group (e.g., at or above an average or other statistical measure of the selection/auction clearing price), or by another selection means. In some embodiments, the performance metrics include the objectives of the campaign such as a click-through rate, return-on-spend, total number of impressions, and so forth. The performance metrics may be based on historical campaigns for the keywords along with predicted frequency of the keywords and associated keyword auction opportunities. As discussed with respect to FIG. 7, the keyword groups and modified bids, along with the associated performance metrics, may be displayed to a user device in an interface for evaluation of the metrics at the modified bids for a selection by a user/sponsor of an override bid for the keyword group.

To determine the predicted performance of the keyword group, the predicted performance of one or more individual keywords in the group may be estimated. Predictive models may estimate the frequency that a keyword appears, clearing price for an auction, predicted frequency of user interaction with the campaign content, and so forth. These may be used to predict additional metrics such as a return relative to budget use (e.g., as a ratio), conversions attributed to the campaign, and so forth. The performance metrics for one or more keywords may be generated and used to determine performance metrics for the keyword group as a whole. In one example, the keyword group metrics are based on the aggregated or weighted metrics for the individual keywords in the group. In some embodiments (e.g., when the total number of keywords in a group may be relatively large or when the performance metrics are expected to be relatively similar across keywords in the group), the performance metrics for the keyword group may be an extrapolation or expansion of performance metrics for individual keywords to estimate the performance metrics for the keyword group. For example, the expected number of times that individual keywords in the group may appear and a frequency that the keyword may win the auction at the modified bid may be determined for each of the keywords. Additional performance metrics (e.g., a click-through rate) may be calculated for a portion of the keywords in the keyword group and extrapolated to describe the keyword group.

An override bid for the keyword group may be set 620, either automatically or based on a user selection (e.g., via an interface of FIG. 7), and the override bid is provided 625 for participation for content selection for keywords in the group (e.g., when a keyword auction is received with a keyword in the group). In some embodiments, the override bid may be automatically set 620 for the keyword group based on the performance metrics and/or objectives for the campaign. For example, the override bid for the keyword group may be set at a level that optimizes one or more performance metrics based on the performance metrics estimated for the various modified bids. Such optimizations may, for example, seek to maximize a return on a budget spent over a campaign duration. An optimization algorithm may also aim to jointly optimize the override bids across the different keyword groups simultaneously based on the respective performance metrics. This may enable the automatic campaign management to optimize return across the entire campaign budget and duration based on the preferred objectives of the sponsor. Together, this approach provides a method for keyword grouping, performance estimates, and override bids that avoid complex user interactions that may otherwise arise, particularly in campaigns with a large number of keywords.

FIGS. 7A-B are example user interfaces 700A-B for a user device operated by a user associated with a campaign sponsor, according to one or more embodiments. The user interfaces 700A-B shown in FIGS. 7A-B show example interfaces for viewing keyword groups, performance metrics at one or more modified bids, and options for setting an override bid for the keyword group. The user interfaces 700A-B show different features and example interface elements in one configuration; in other configurations, fewer or more elements are provided in different ways. The user interfaces 700A-B may be provided to a user associated with the sponsor of a campaign for viewing information related to keyword groups. The user interfaces 700A-B may be provided to the user for management of keyword groups of a campaign; additional interfaces may be provided for providing additional information and campaign parameters, such as a campaign budget, a set of keywords, campaign objectives, and so forth. The user interfaces 700A-B may be accessed during creation of a content campaign or may be used during operation of a campaign to manage keyword groups. The user interfaces 700A-B may be provided to the user device for display to the sponsor by a component of the online system that manages campaigns and campaign creation, such as the campaign manager 322 or the campaign generation module 326, in one example. Similarly, when a user provides an input to the interface, the input from the user may be provided by the user device to the corresponding component of the online system to manage the campaign.

The user interface 700A provides a selection interface element 710 for a user to select a keyword group. In this example, the selection interface element 710 is a drop-down menu in which a user may select a category for the keyword group, shown in this example as the “popular” keywords as discussed above. When the user selects a category, information about the related keyword group is provided to the user. The categories may be a set of predefined categories, such as the set of categories discussed above, and may include an option to define a custom group of keywords. When the user selects a custom group of keywords, the user may manually search for or enter keywords for the keyword group, or may enter a keyword for which the keyword group may be based on (e.g., relevance to the entered keyword). The user interface 700A may also include one or more additional characteristics to be selected for the keyword group. For example, in addition to the category, the interface may also provide an interface element for a user to select a keyword group of the category with keywords that are predicted to have either a higher or lower override bid. For example, the user may select a category of “popular” in conjunction with “predicted lower keyword bid” to view a keyword group of keywords jointly predicted to belong in the popular category along with lower keyword bids.

The keywords and other information about the keywords and keyword group (e.g., performance metrics) for a particular keyword group may be pre-calculated or may be determined in response to a user selecting a category. For example, in one configuration, the system determines keywords to form keyword groups in each of the selectable categories and determines estimated performance metrics before a user selects a category in the selection interface element 710, and in another, the particular keywords and performance metrics are determined in response to a selection. For example, performance metrics of a keyword group may be re-calculated when a user forms a custom keyword group or when a user modifies the keywords in a keyword group.

For the selected keyword group, a current bid 720 for the keyword group and predicted performance metrics 730 for the keyword group at the current bid 720 may be displayed to the user. The current bid 720 may be the campaign-level bid or, if active, the override bid for the keyword group. The interface for the current bid 720 may also permit the user to modify the current bid 720 to set an override bid for the selected keyword group based on the performance metrics. In this example, the predicted performance metrics 730 may display the predicted metrics for the keyword group at the current bid 720. The user interface 700A also includes a display of keywords in a keyword subset 740 that form the keyword group. Each of the keywords in the keyword subset 740 may also be displayed with predicted performance metrics 750 for the respective metrics of the keyword at the current bid 720. The keyword subset 740 may also include interface elements (not shown) for a user to modify the keyword group (which may have been automatically generated), or to add or remove campaign keywords to the keyword group.

The user interface 710A may also include a performance graph 760A of a particular performance metric with respect to different modified bids. The performance graph 760A displays the effect of different override bids for the keyword group on the keyword campaign.

In this example, the user interface 700A includes a bid landscape interface element 770 for the user to access further information about the performance metrics at different modified bids for the keyword group. In this example, when a user interacts with the bid landscape interface element 770, the user interface 700B as shown in FIG. 7B is displayed to the user.

The user interface 700B provides additional details for the selected keyword group with respect to different modified bids. In this example, the user interface 700B shows a performance metric display 780 that includes various modified bids that were evaluated for the keyword group. The performance metrics 790 calculated for each modified bid are displayed to the user for the user to readily view the effects of different bid values on the expected performance of the keyword group. In addition, the performance metrics, as they vary at different modified bids, may be displayed in a performance graph 760B. Finally, the user may select a modified bid (e.g., via a radio button as displayed in FIG. 7B) and set the modified bid via a bid set interface element 795 as the override bid for the keyword group. Using the automated creation of keyword groups and performance metrics, the online system may thus improve the customization of keyword campaigns by sponsors, allowing sponsors to readily create content campaigns with a large number of keywords and use interfaces such as those in FIGS. 7A-B to set customized override bids for the keyword group. For example, after creating a campaign, the user may access the user interface 700A to select a keyword group, verify that the displayed keywords include the keywords of interest to the sponsor for that keyword group, and view performance metrics for the different modified bids to set the override bid for the keyword group quickly. This may significantly improve the interface for sponsors in creating these campaigns and allow intelligent customization of keyword campaigns.

### ADDITIONAL CONSIDERATIONS

The foregoing description of the embodiments has been presented for the purpose of illustration; it is not intended to be exhaustive or to limit the claims to the precise forms disclosed. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope be limited not by this detailed description, but rather by any claims that issue on an application based hereon. Accordingly, the disclosure of the embodiments is intended to be illustrative, but not limiting, of the scope, which is set forth in the following claims.

1. A method comprising, at a computer system comprising a processor and a computer-readable medium:
identifying a content campaign having a campaign-level bid, a plurality of keywords, and a sponsor;
automatically determining, based on a primary trained computer model, a primary keyword group having a subset of keywords of the plurality of keywords, wherein the primary trained model is trained using a scoring of the plurality of keywords with respect to a primary category;
determining predicted performance metrics for the primary keyword group at a plurality of modified bids that are different from the campaign-level bid;
presenting, in a graphical user interface, the predicted performance metrics for the primary keyword group at the plurality of modified bids that are different from the campaign-level bid, comprising:
displaying, in the graphical user interface, a graphical presentation of at least one predicted performance metric at different modified bids, and
responsive to a user interaction with one or more user interface elements in the graphical user interface, modifying the graphical presentation illustrating a change to the at least one predicted performance metric corresponding to the user interaction;
receiving a user selection of an override bid value for the subset of keywords that is different from the campaign-level bid; and
using the override bid in a process for selection of the content campaign in response to a keyword in the keyword subset matching a keyword auction opportunity.

2. The method of claim 1, further comprising:
automatically determining, based on a second trained computer model, a second keyword group having a second subset of keywords of the plurality of keywords, wherein the second trained model is trained using a scoring of the plurality of keywords with respect to a second category, wherein the second category is different than the primary category;
determining predicted performance metrics for the second keyword group at a plurality of modified bids that are different from the campaign-level bid; and
displaying the predicted performance metrics for the second keyword group at the plurality of modified bids that are different from the campaign-level bid.

3. The method of claim 1, further comprising:
causing the keyword subset with the predicted performance metrics to be displayed on a user device; and
receiving the override bid for the keyword subset from the user device;
wherein setting the override bid is performed responsive to receiving the override bid.

4. The method of claim 1, wherein the scoring of the plurality of keywords with respect to the primary category comprises a label indicating a relevance of a keyword to a content item of the content campaign.

5. The method of claim 2, wherein the scoring of the plurality of keywords with respect to the second category comprises a label indicating a keyword frequency of keyword auction opportunities.

6. The method of claim 1, further comprising:
training the primary computer model based on a set of prior content campaigns by the sponsor having keywords with different bids, wherein the training comprises, for each of a set of training keywords:
applying the primary computer model to the training keyword,
comparing an output of the primary computer model with a scoring of the training keyword with respect to the primary category, and
backpropagating through the primary computer model based on the comparing to update one or more parameters of the primary computer model.

7. The method of claim 1, wherein determining predicted campaign metrics comprises determining predicted metrics for a portion of the keywords of the keyword group and aggregating the metrics for the keyword group.

8. A computer program product comprising a non-transitory computer readable storage medium having instructions encoded thereon that, when executed by a processor, cause the processor to perform steps comprising:
identifying a content campaign having a campaign-level bid, a plurality of keywords, and a sponsor;
automatically determining, based on a primary trained computer model, a primary keyword group having a subset of keywords of the plurality of keywords, wherein the primary trained model is trained using a scoring of the plurality of keywords with respect to a primary category;
determining predicted performance metrics for the primary keyword group at a plurality of modified bids that are different from the campaign-level bid;
presenting, in a graphical user interface, the predicted performance metrics for the primary keyword group at the plurality of modified bids that are different from the campaign-level bid, comprising:
displaying, in the graphical user interface, a graphical presentation of at least one predicted performance metric at different modified bids, and
responsive to a user interaction with one or more user interface elements in the graphical user interface, modifying the graphical presentation illustrating a change to the at least one predicted performance metric corresponding to the user interaction;
receiving a user selection of an override bid value for the subset of keywords that is different from the campaign-level bid; and
using the override bid in a process for selection of the content campaign in response to a keyword in the keyword subset matching a keyword auction opportunity.

9. The computer program product of claim 8, wherein the instructions further cause the processor to perform steps comprising:
automatically determining, based on a second trained computer model, a second keyword group having a second subset of keywords of the plurality of keywords, wherein the second trained model is trained using a scoring of the plurality of keywords with respect to a second category, wherein the second category is different than the primary category;
determining predicted performance metrics for the second keyword group at a plurality of modified bids that are different from the campaign-level bid; and
displaying the predicted performance metrics for the second keyword group at the plurality of modified bids that are different from the campaign-level bid.

10. The computer program product of claim 8, wherein the instructions further cause the processor to perform steps comprising:
causing the keyword subset with the predicted performance metrics to be displayed on a user device; and
receiving the override bid for the keyword subset from the user device;
wherein setting the override bid is performed responsive to receiving the override bid.

11. The computer program product of claim 8, wherein the scoring of the plurality of keywords with respect to the primary category comprises a label indicating a relevance of a keyword to a content item of the content campaign.

12. The computer program product of claim 9, wherein the scoring of the plurality of keywords with respect to the second category comprises a label indicating a keyword frequency of keyword auction opportunities.

13. The computer program product of claim 8, wherein the instructions further cause the processor to perform steps comprising:
training the primary computer model based on a set of prior content campaigns by the sponsor having keywords with different bids, wherein the training comprises, for each of a set of training keywords:
applying the primary computer model to the training keyword,
comparing an output of the primary computer model with a scoring of the training keyword with respect to the primary category, and
backpropagating through the primary computer model based on the comparing to update one or more parameters of the primary computer model.

14. The computer program product of claim 8, wherein determining predicted campaign metrics comprises determining predicted metrics for a portion of the keywords of the keyword group and aggregating the metrics for the keyword group.

15. A computer system comprising:
a processor; and
a non-transitory computer-readable storage medium having instructions that, when executed by the processor, cause the computer system to perform steps comprising:
identifying a content campaign having a campaign-level bid, a plurality of keywords, and a sponsor;
automatically determining, based on a primary trained computer model, a primary keyword group having a subset of keywords of the plurality of keywords, wherein the primary trained model is trained using a scoring of the plurality of keywords with respect to a primary category;
determining predicted performance metrics for the primary keyword group at a plurality of modified bids that are different from the campaign-level bid;
presenting, in a graphical user interface, the predicted performance metrics for the primary keyword group at the plurality of modified bids that are different from the campaign-level bid, comprising:
displaying, in the graphical user interface, a graphical presentation of at least one predicted performance metric at different modified bids, and
responsive to a user interaction with one or more user interface elements in the graphical user interface, modifying the graphical presentation illustrating a change to the at least one predicted performance metric corresponding to the user interaction;
receiving a user selection of an override bid value for the subset of keywords that is different from the campaign-level bid; and
using the override bid in a process for selection of the content campaign in response to a keyword in the keyword subset matching a keyword auction opportunity.

16. The computer system of claim 15, wherein the instructions further cause the processor to perform steps comprising:
automatically determining, based on a second trained computer model, a second keyword group having a second subset of keywords of the plurality of keywords, wherein the second trained model is trained using a scoring of the plurality of keywords with respect to a second category, wherein the second category is different than the primary category;
determining predicted performance metrics for the second keyword group at a plurality of modified bids that are different from the campaign-level bid; and
displaying the predicted performance metrics for the second keyword group at the plurality of modified bids that are different from the campaign-level bid.

17. The computer system of claim 15, wherein the instructions further cause the processor to perform steps comprising:
causing the keyword subset with the predicted performance metrics to be displayed on a user device; and
receiving the override bid for the keyword subset from the user device;
wherein setting the override bid is performed responsive to receiving the override bid.

18. The computer system of claim 15, wherein the scoring of the plurality of keywords with respect to the primary category comprises a label indicating a relevance of a keyword to a content item of the content campaign.

19. The computer system of claim 16, wherein the scoring of the plurality of keywords with respect to the second category comprises a label indicating a keyword frequency of keyword auction opportunities.

20. The computer system of claim 15, wherein the instructions further cause the processor to perform steps comprising:
training the primary computer model based on a set of prior content campaigns by the sponsor having keywords with different bids, wherein the training comprises, for each of a set of training keywords:
applying the primary computer model to the training keyword,
comparing an output of the primary computer model with a scoring of the training keyword with respect to the primary category, and
backpropagating through the primary computer model based on the comparing to update one or more parameters of the primary computer model.
